(19) United States
(12) Patent Application Publication
(10) Pub. No.: US 2016/0050897 A1
(43) Pub. Date: Feb. 25, 2016

(54) Fish Call

(71) Applicant: Frank Crescitelli, Staten Island, NY (US)

(72) Inventor: Frank Crescitelli, Staten Island, NY (US)

(21) Appl. No.: 14/878,608

(22) Filed: Oct. 8, 2015

Related U.S. Application Data
(62) Division of application No. 13/709,191, filed on Dec. 10, 2012, now abandoned.

(51) Int. Cl. A01K 85/01; A01K 91/04; A01K 85/16

(52) U.S. Cl. CPC A01K 85/01; A01K 85/16; A01K 91/04

(57) ABSTRACT

A bucktail fish call comprising: a body having an upper end substantially opposed to a lower end and a proximal end substantially opposed to a distal end, where the distal end contains a first hook, the upper end contains a first loop fastener and the bottom end contains a second loop fastener having a second hook, and where the body comprises at least one capsule containing a plurality of beads.

### CROSS-REFERENCE TO RELATED APPLICATION

This application is a divisional of U.S. patent application Ser. No. 13/709,191 filed on Dec. 10, 2012, entitled “FISHING LURE”, by Gregory Myerson and Frank Crescitelli, the entirety of which is incorporated by reference.

### TECHNICAL FIELD

The present invention is generally directed to a fish call.

### BACKGROUND OF THE INVENTION

Striped bass, also known as stripers or rockfish, have a lifespan of up to thirty years. Adult striped bass can grow to be over one hundred pounds and up to six feet long. Striped bass are often found near rocky reefs and shipwrecks. It is known that large striped bass feed on lobsters and other invertebrates that are found hi ding in or around rocky areas. Freshwater bass are known to feed on crayfish and other invertebrates that inhabit rocky areas of lakes or rivers.

Striped bass are lazy feeders that do not go out of their way to get food. They often eat fish and other food flowing by in the current or prey on animals that are close by. Unlike many other fish, striped bass do not actively seek prey.

Fishing for bass is very popular in sport fishing. When fishing for striped bass from a boat, fishermen often use a fishing rod and line with a weight, also known as a sinker, which falls to the water's bottom and a leader trailing behind the sinker that has a baited hook on the end. The leader and the baited hook flow with the current and presents food to the fish. Often the bait used is an eel. However, due to the nature of striped bass, they will strike at the bait only if it is presented directly to them. Since the exact location of the fish is unknowable, this behavior makes fishing for striped bass a hit or miss affair.

Although much freshwater bass fishing is done on the surface with so-called popper or spinner lures, fishermen sometimes use a deep water technique similar to fishing for striped bass when fishing for freshwater bass. The difference is in the size of the weight and hook (which are naturally much smaller than for striped bass) and the bait (which is often artificial). This freshwater fishing technique is sometimes called “drop shot”.

Conventional noise-making lures and weights have a linear noise-making device. In most designs, the outside diameters of the noise-making beads are approximately the same size as the inside diameter of the noise-making chamber. This linear type of noise-making device fails to accurately mimic an invertebrate prey because it does not produce a sound of multiple legs walking on the water's rocky bottom. Further, lures and weights that incorporate this linear device typically place the noise-making device on the jig-head, which subjects itself to easy breakage and snagging and impedes the ability to attach bait to the hook, or place a single noise-making chamber within the jig head, which muffles the rattle sound.

Other conventional noise-making lures and weights that incorporate multiple loose rattle members only create the rattling sound from a linear, one-direction motion. Such devices are designed to be fished using a technique of jigging or twisting, but cannot do both. Such designs also have complicated noise-making chambers that require internal sections of the lure to be hollow while still enabling the fishing line to pass-through the lure's body. These designs drastically increase the cost of manufacturing.

Currently, fishermen use conventional noise-making lures and weights that are designed and built to be used near the water's surface and in medium depth waters to fish off the water's bottom. These noise-making lures are designed and built to only attract the small, top-feeder fish and are difficult to use off the water's bottom because they lack the durability to withstand the continuous thrashing against a rocky bottom. Such lures and weights are also not successfully fished off the water's bottom because they do not produce an adequate sound that mimics an invertebrate prey that is walking on the bottom nor do they produce a multi-dimensional, complex sound that enables the lure to be jigged or twisted in the current. As a result, using a conventional noise-making lure or weight off the water's bottom does not attract the larger, bottom-feeder fish that are the most desirable to catch.

Traditional lures and weights not only lack the durability to be used to fish off the water's bottom, but they also lack versatility. A fisherman typically needs multiple different types of weights for different fishing techniques and then also needs an associated lure. As a result, a fisherman is forced into having to carry pounds of various lead sinker weights and multiple different types of tackle, rather than being able to dress a single sinker weight as a lure.

The introduction of lead into the human body is another issue facing the fishing industry. As it is commonly known, lead is a harmful heavy metal in which toxic levels can build up in the body over time. The most common ways of introducing lead into the body are ingestion and inhalation. Avid fishermen's repeated handling of lead weights and then touching their mouths or eating without washing their hands, or adjusting lead weights with their teeth, a common bad habit among many fishermen, can introduce lead into their systems.

Accordingly, it is desirable to have a combination fish call and weight that incorporates a multi-dimensional noise-making device that attracts fish, particularly striped bass and freshwater bass, by mimicking the sound of invertebrate prey walking on the water's rocky bottom. It is also desirable to have a fish call and weight that is versatile so that fishermen can carry less tackle, built to withstand the rough abuse of fishing off the water's rocky bottom, and has a protective coating covering the lead weight to protect fishermen from harmful lead exposure.

### SUMMARY OF THE INVENTION

The invention relates to a bucktail fish call comprising: a body having an upper end substantially opposed to a lower end and a proximal end substantially opposed to a distal end, where the distal end contains a first hook, the upper end contains a first loop fastener and the bottom end contains a second loop fastener having a second hook, and where the body comprises at least one capsule containing a plurality of beads.

The invention relates to a fish call comprising: an acoustically tuned body having an outer envelope; and a capsule containing a plurality of beads consisting of at least two different sizes having a ratio of 1:1.25, where the capsule is substantially encompassed by the body, and where the plurality of beads produces a sound that mimics an invertebrate prey moving underwater.

The invention is a combination fish call and weight that produces sound that is very attractive to fish, particularly striped bass and freshwater bass. In one embodiment, the invention has a body having an outer envelope and a capsule having an inboard axial extremity to the body of the lure and an outboard axial extremity extending beyond the envelope. The capsule contains a plurality of beads, which enables the lure to mimic the sound of invertebrate prey walking on the water's rocky bottom.

In another embodiment, the combination fish call and weight has a body that contains at least two capsules that contain a plurality of beads. These capsules are positioned in such a manner that they substantially oppose one another. This positioning creates a multi-directional rattling noise that produces a multi-dimensional, complex sound that mimics invertebrate prey and is able to produce the desired rattling sound even if the fisherman is jigging off the water's bottom or letting the combination lure and weight twist in the water's current.

In yet another embodiment, the sound is produced from a bucktail fish call comprising a body having at least one capsule containing a plurality of beads. The lure also contains a first and second hook, wherein the second hook is located off the bottom end of the lure.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a cross-sectional view of the combination lure and weight;

FIG. 2 is a plan view of the line setup of one embodiment of the invention;

FIG. 3 is a plan view of one embodiment of the combination lure and weight;

FIG. 4 is a cross-sectional view of one embodiment of the combination lure and weight;

FIG. 5 is a plan view of the bucktail lure, which is one embodiment of the invention; and

FIG. 6 is a cross-sectional view of the bucktail lure, which is one embodiment of the invention.

### DETAILED DESCRIPTION

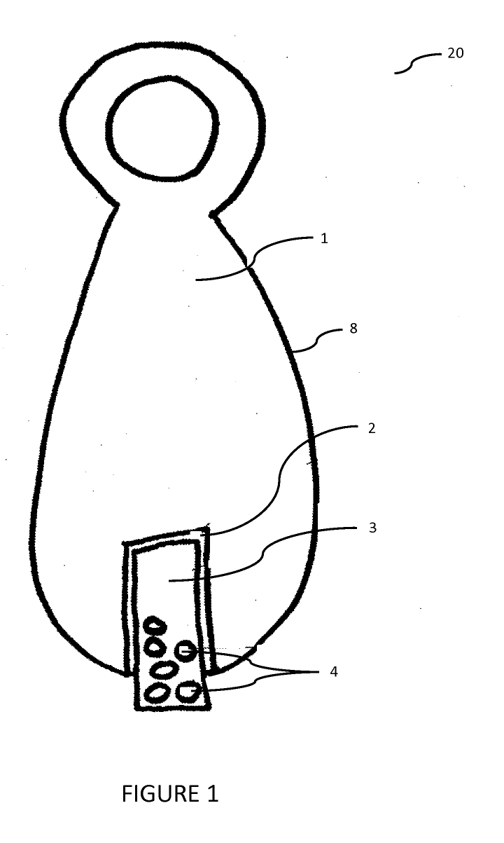

The present invention is a combination fish call and weight to be used in fishing, and preferably fishing for saltwater, striped bass or freshwater, largemouth, smallmouth, or spotted bass. FIG. 1 shows the combination fish call and weight 20 comprised of a body 1 that has a cavity 2 containing a capsule 3. The capsule 3 is a sealed watertight rigid hollow tube, and inside of the capsule 3 are at least two beads 4. The beads 4 should be able to move freely inside the capsule 3 so that a rattling noise that mimics the sound of invertebrate prey moving around on rocks is created. Some portion of the capsule 3 extends outward from the cavity 2 and beyond the outer envelope 8 of the body 1 so that the sound of the beads 4 moving or rattling may be clearly heard. In the embodiment of the invention shown in FIG. 1, the capsule 3 contains six beads 4.

The body 1 can be made of any suitable dense material, including but not limited to lead. The outer envelope 8 may contain an epoxy protective coating so that fishermen can safely handle the lure when the body 1 is made of a hazardous material, such as lead. In one embodiment, the body 1 can be an ordinary lead sinker, between approximately one ounce and approximately twenty-four ounces in weight when fishing for striped bass or freshwater bass. The weight of the body 1 should be chosen to suit the conditions, such as boat speed, current, and the like. The only requirement for the weight of the body 1 is that it be sufficient to carry the end of the line to the bottom of the ocean, lake or river under the prevailing conditions. The choice of the body 1 weight for given fishing conditions is within the ordinary skill of a fisherman. The cavity 2 can be created by drilling into the body 1 to cause a hole into which the capsule 3 is inserted. Alternatively, the body 1 may be created by molding a dense material around the capsule 3. The composition of the material and the interface between the capsule and shell material can be tuned such that the overall timber the sound produced by the capsule-lure is optimized to simulate natural prey characteristics.

The capsule 3 can be made of glass tubing or other rigid materials, such as plastic and metal. The capsule 3 is not limited to any specific diameter of tube or beads 4 as long as it is capable of producing the desired rattling sound. The capsule contains the beads 4 in a vacuum chamber. The minimal air resistance within the vacuum chamber helps the beads 4 to create the desired rattling sound, however a non-vacuum chamber may also be utilized.

The ratio between the inside diameter of the capsule 3 and the diameters of the beads 4, as well as the number of beads 4, should be such as to allow the beads 4 to freely move within the capsule 3. It should be understood by one of ordinary skill in the art that the inside diameter of the capsule 3 and the diameters of the beads 4, as well as the number of beads 4, are not critical provided that the relationship between them is such that the beads 4 can freely move within the capsule 3 to produce the desired rattling sound. This ratio allows the beads 4 to move freely and produce the rattling sound as the combination lure and weight 20 moves, either jigged off the water's bottom or twisted in the current. In one embodiment, the number of beads 4 in the capsule 3 is approximately five to seven, while the ratio between the inside diameter of the capsule 3 and the diameter of each bead 4 is about two or slightly greater than two to one. Bearing in mind the overall size ratio between the beads and capsule, the beads used may be of different sizes and materials, in order to produce a desired timbre of sound projected by the lure. The desired timbre may thus render the lure more attractive to a specific particular fish species. The ratio of bead sizes can be 1:1.5 while still maintaining an overall average size ratio of 2:1 between the capsule and beads. In one embodiment, the ratio of bead sizes is 1:1.25, while maintaining the overall average size ratio of 2:1 between the capsule and the beads.

The beads 4 inside the capsule 3 may be made of any suitable solid material, including but not limited to metal, which will make a rattling sound while in use. In one embodiment, steel balls are used because of their accessibility and low cost. However, one could also employ beads or balls of other solid materials, such as other metals (e.g., copper or brass), glass, or ceramic.

For larger lures, one embodiment of the invention includes a capsule 3 comprising a sealed watertight piece of one inch inside diameter glass tubing and beads 4 comprising a plurality of half-inch (12.7 mm) steel balls. While another embodiment of the invention includes a capsule 3 comprising a sealed watertight piece of three-eighths inch (9.5 mm) inside diameter glass tubing and beads 4 comprising a plurality of 4.7 mm steel balls.

For smaller lures, one embodiment of the invention includes a capsule 3 comprising a sealed watertight piece of 9.5 mm inside diameter glass tubing and beads 4 comprising a plurality of 1.6 mm steel balls.

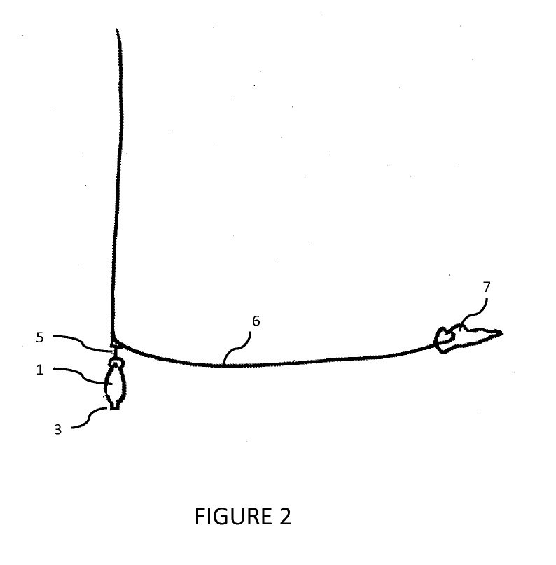

FIG. 2 shows the setup of a fishing line using the combination lure and weight 20. The fishing line 5 connected to the body 1 of the lure having the capsule 3 with beads 4 (not shown) contained therein. The leader 6 is attached to the line 5 proximate to the body 1. Alternatively, the leader 6 can be attached to the line 5 above the body 1. The exact location on line 5 where leader 6 is attached is a matter of convenience. At the terminal end of the leader 6 is a hook and bait 7. This leader 6 with hook and bait 7 is what the fish will see and strike when moving toward the sound created by the combination lure and weight 20. When fishing for striped bass, the preferred bait 7 is an eel, but other baits commonly used in fishing are also envisioned.

To use the invention, a fisherman would lower the line with the invention until the lure is close to the bottom of the ocean, lake, or river and slowly troll. The motion of the lure during trolling will rattle the beads 4 inside the capsule 3. Ideally the best time to use the invention for striped bass is during the night when the striped bass are out feeding. Also, fishing near rocky reefs where striped bass often hide will increase the usefulness of this invention. Without intending to be bound by any particular theory, the inventor believes that when a fish, particularly a striped bass or freshwater bass, hears the sound caused by the invention, the fish believes the sound is caused by a lobster (in the case of a striped bass) or a crayfish (in the case of a freshwater bass) walking on the rocks and will move toward the sound. When the fish senses the bait 7 at the end of the leader 6, the fish will strike.

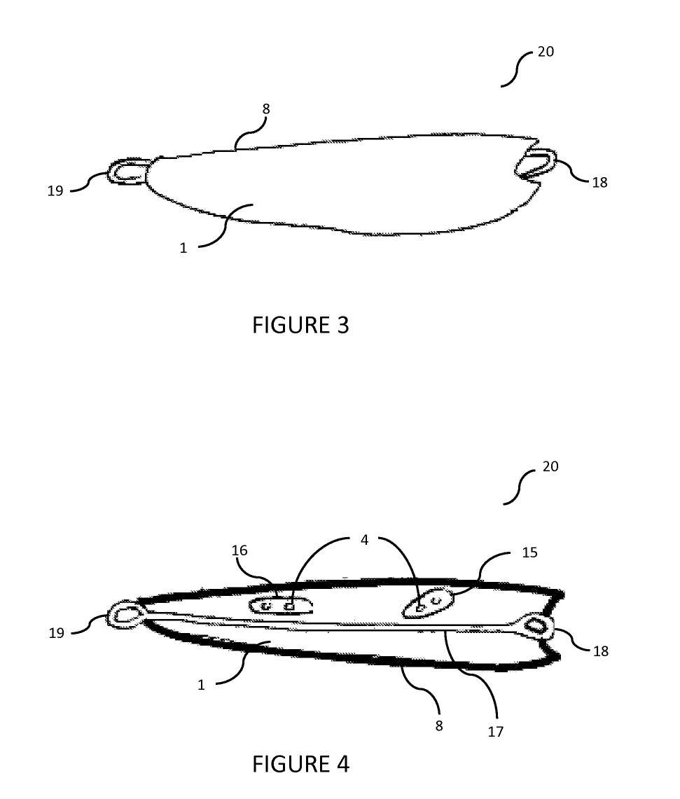

FIGS. 3 and 4 illustrate another embodiment of the invention. In this embodiment, the combination lure and weight 20 contains an elongated body 1, an outer envelope 8, two noise-making capsules 15 and 16, and a connecting wire 17, which incorporates the eyelets 18 and 19. The body 1 is made of a dense material, including but not limited to lead and the elongated shape enables the weight to act like a lure, whereby it can “swim” through the water. As a result, this embodiment enables the combination lure and weight 20 to act as a stationary sinker, slip sinker, and a lure by attaching a hook onto eyelet 19. Eyelet 19 is a loop of wire created from connecting wire 17, which is a single, continuous piece of wire that runs completely through the body 1 to produce eyelets 18 and 19. Eyelet 18 is also a loop of wire, which is used to fasten the fishing line from the fishing pole.

The outer envelope 8 may contain an epoxy protective coating so that fishermen can safely handle the lure when the body 1 is made of a hazardous material, such as lead. In one embodiment, the protective coating is red because of the color's relatively long wavelength, which enables the color to become absorbed into the water's surrounding colors at a water column depth of approximately 15-20 feet.

As illustrated in FIG. 4, capsules 15 and 16 are substantially the same as capsule 3, as previously described herein. However, capsule 16 is a ⅜ inch long tube that is axially positioned inside of the body 1, while capsule 15 is a ¾ inch long tube that is positioned approximately 30° to 60° away from the axially positioned capsule 16. Capsules 15 and 16 contain beads 4 that are of different sizes ranging from approximately 1.6 mm to approximately 12.7 mm. The beads 4 may be the same or different sizes within the capsule. The capsules 15 and 16 are vacuum chambers, which allow the beads 4 to move more freely within the capsules. This two-capsule design, with one capsule positioned approximately 30° to 60° away from an axial-positioned capsule, enables the combination lure and weight 20 to produce a multi-dimensional, complex sound that mimics invertebrate prey and is able to produce the desired rattling sound even if the fisherman is jigging off the water's bottom or letting the combination lure and weight 20 twist in the water's current.

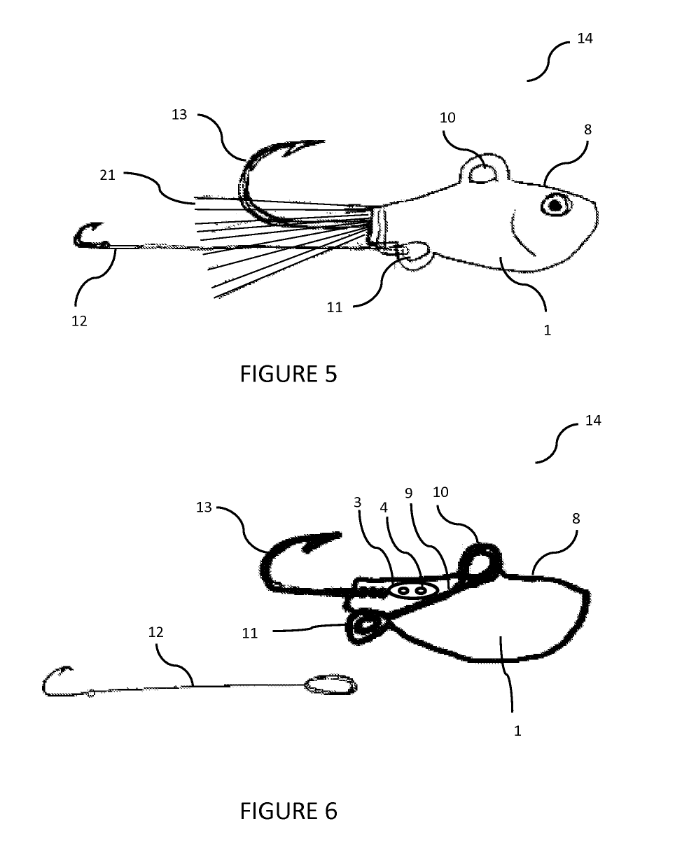

In another embodiment, the capsule design is incorporated into a bucktail fish call 14. As illustrated in FIGS. 5 and 6, this bucktail fish call 14 contains a body 1, an outer envelope 8, a noise-making capsule 3 with beads 4, a continuous wire 9 with eyelet 10 and stinger hook attachment 11, and an optional stinger wire and hook 12. The body 1 also contains a tail 21 and hook shank 13. Within the body 1, the noise-making capsule 3 is attached to the hook shank 13 to transmit the rattling sound through the metal hook shank 13. In one embodiment, the bucktail fish call 14 incorporates a two capsule noise-making design to produce a multi-dimensional, complex sound.

In use, the fishing line from a fisherman's pole attaches to the eyelet I0, while the stinger hook attachment II enables a fisherman to attach the optional stinger wire and hook 12, which allows a fisherman to attach bait to the bucktail fish call 14 without affecting the lure's swimming abilities. The continuous wire 9, which incorporates the eyelet 10 and stinger hook attachment II, allows the force from a fish strike to be carried directly to the fisherman's line. This eliminates the risk of having a fish pull an attaching eyelet out from the body I and increases the fisherman's line sensitivity. The line sensitivity is increased because the fish's striking force travels directly from the optional stinger wire and hook 12, through the continuous wire 9, and directly to the fishing line rather than travelling through the body 1. In another embodiment, the hook shank 13 is also connected to the continuous wire 9 or eyelet 10 to minimize the risk of the hook shank 13 from being pulled out of the body 1 and to also increase the fisherman's line sensitivity.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

### EXAMPLE

In order that this invention be more fully understood, the following example is set forth. This example is for the purpose of illustrating certain embodiments of this invention, and is not to be construed as limiting the scope of this invention in any way.

Rattling sound levels were measured for the purpose of reference. Measurements were taken from a digital oscilloscope for a time period of ten seconds and were recorded in decibels (db). All measurements were taken approximately three inches from the oscilloscope's recording probe in approximately one atmosphere of pressure.

The average sound level produced by the capsule containing the beads, as described herein and shown in FIG. 1, ranged from approximately 56 db to approximately 64 db. The average sound level produced by the capsule placed in the body of the combination lure and weight, as described herein and shown in FIG. 4, ranged from approximately 47 db to approximately 63 db. The average sound level produced by the capsule placed in the body of the bucktail fish call, as described herein and shown in FIG. 6, ranged from approximately 47 db to approximately 59 db.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. The disclosed embodiments are illustrative, not restrictive. While specific configurations of the disclosed invention have been described, it is understood that the present invention can be applied to a wide variety of configurations. There are many alternative ways of implementing the invention.

What is claimed is:

1. A bucktail fish call comprising:
a body having an upper end substantially opposed to a lower end and a proximal end substantially opposed to a distal end, wherein the distal end contains a first, the upper end contains a first loop fastener and the bottom end contains a second loop fastener having a second hook, and wherein the body comprises at least one capsule containing a plurality of beads.

2. The fish call of claim 1 wherein the body has an axially positioned capsule.

3. The fish call of claim 1 wherein the capsule is a watertight hollow rigid tube between approximately 0.375 inches and approximately 0.75 inches long.

4. The fish call of claim 3 wherein the inside diameter of the tube is between approximately 9.5 and approximately 25.4 millimeters.

5. The fish call of claim 1, wherein the diameter of each individual bead is approximately between 1.6 and approximately 12.7 millimeters.
